(19) United States
(12) Patent Application Publication
(10) Pub. No.: US 2026/0289599 A1
(43) Pub. Date: Sep. 24, 2026

(54) TARGETED AUDIENCE PRE-AGGREGATION AND MAINTENANCE IN AN AUDIENCE MANAGEMENT PLATFORM

(71) Applicant: Target Brands, Inc.,, Minneapolis, MN (US)

(72) Inventors: Kristina Taylor, Minneapolis, MN (US); Darren Naylor, Minneapolis, MN (US); Dan Johnson, Minneapolis, MN (US); Vishal Patil, Minneapolis, MN (US); William Fraley, Minneapolis, MN (US)

(21) Appl. No.: 19/082,734

(22) Filed: Mar. 18, 2025

(51) Int. Cl. G06Q 30/0204

(52) U.S. Cl. CPC G06Q 30/0204

(57) ABSTRACT

In example aspects, an audience management platform is described in which targeted audience segments are pre-aggregated. Audiences may be defined based on a criteria for membership in the audience, with audience members being determined from among an eligible audience population. The criteria may be defined by predicted behavior as determined by one or more behavioral models, optionally in combination with other deterministic criteria. Individual audience segments associated with each criterium may be created and audiences formed from those audience segments. Pre-populated audience memberships, or audience segment memberships enable quick formation of custom audiences and exposure to consumers of audience definitions of the size of a given audience. Audiences are maintained according to defined update frequencies.

### BACKGROUND

It is often the case that a large enterprise may wish to identify a collection of target users, or potential users, or a good or service. Such users may be addressed with communications indicating potential features of the good or service, via directed communication. An enterprise may wish to identify those users by a particular set of criteria, such as individuals who have interacted with the good or service within a predetermined period (e.g., within the last week, month, etc.), or may identify users who have recently purchased items that may suggest interest in the good or service. These attribute-based definitions of users generally are resolved to identify a particular audience of users either (1) at the time the criteria is defined, or (2) at the time a communication or interaction with those users is initiated by the enterprise.

Such arrangements have drawbacks. With respect to the definition of an audience at the time criteria is defined, that audience, or collection of discrete, identifiable users, will likely be stale at the time a communication is initiated. This is because some users may fall outside of defined criteria by the time such communication is initiated, while others may meet the criteria but may only have done so based on activity occurring after the audience is created. This can result in missed potential audience members, as well as audience members for which communications may be unwelcome (e.g., those who no longer meet the desirable criteria to be within the audience). Furthermore, with respect to creation of an audience at the time of communication, it can be difficult to manage communications in that case. This is because it may be difficult to easily determine the number of users to which a communication may be released (since the specific user group has not yet been resolved), and therefore the expense, in terms of effort and computational resources to initiate digital communications (e.g., email, text, application notifications, and the like) prompting the user to interact with the good or service may be high. For enterprise users who are required to manage the cost of various communication campaigns, this uncertain audience size or makeup may lead to significant uncertainty. There may also be delay in generating such digital communications, since it will take time to resolve the preferences of the entire universe of available users who may be interested in interacting with a good or service that is widely available (e.g., offered by a large retail organization, software provider, or the like).

### SUMMARY

In general, a platform for audience pre-aggregation and maintenance is provided. Audiences may be defined based on a criteria for membership in the audience, with audience members being determined from among an eligible audience population, such as all known users to an enterprise. The criteria may be defined by predicted behavior as determined by one or more behavioral models, optionally in combination with other deterministic criteria. Individual audience segments associated with each criterium may be created and audiences formed from those audience segments. Pre-populated audience memberships, or audience segment memberships enable quick formation of custom audiences and exposure to consumers of audience definitions of the size of a given audience, enabling better control over the extent to which audience communications are spread.

In a particular example aspect, an audience management platform comprises a computing system that includes one or more computing devices, each having a processor and a memory. The platform includes an interface to a plurality of enterprise data repositories, such as a user identity database, an affinity propensity database, and a user activity database associated with an enterprise. It also features a user portal accessible to one or more enterprise user computing devices, which generates a user interface. The user interface includes an audience selection screen that is useable to select from among a plurality of predefined audiences. It also has an audience details screen that is useable to display the criteria used to form a selected audience from among the predefined audiences and includes information regarding the number of members of the selected audience. Additionally, there is an audience definition screen that includes a plurality of fields useable to define criteria for forming an audience definition. The platform is configured to generate an audience in response to receiving the audience definition. This audience includes a plurality of user identifiers corresponding to users meeting the defined criteria. Generating the audience involves retrieving one or more audience segments, each of which includes a plurality of user identifiers and is based on a criterium included in the audience definition. The platform then stores the one or more audience segments in intermediate storage and formulates the audience based on the audience definition by combining the one or more audience segments into an aggregated collection of user identifiers obtained from the one or more audience segments.

In a second aspect, a method includes receiving an audience definition including a plurality of criteria required of each member of an audience; generating a technical specification corresponding to the audience definition, the technical specification being a request for an audience including a plurality of user identifiers, the request including at least one of (1) an identification of a previously-identified audience or (2) a specification of an audience to be provided, the specification including a plurality of criteria required of each member of the audience; generating a technical specification corresponding to the request, the technical specification defining data requests from a plurality of data sources including a user identity database, an affinity propensity database, and a user activity database associated with an enterprise. The method further includes creating and storing in intermediate storage a plurality of audience segments by identifying user identifiers of potential audience members associated with each criterium of the plurality of criteria based on data obtained from the plurality of data sources in accordance with the technical specification; and formulating the audience based on the audience definition, including combining the one or more audience segments into an aggregated collection of user identifiers obtained from the plurality of audience segments.

In a third aspect, an audience management system includes a plurality of data sources including a user identity database, an affinity propensity database, and a user activity database associated with an enterprise; a computing system including one or more processors and a memory; and a user interface accessible via a user portal. The user interface includes an audience selection screen configured to display a plurality of predefined audiences, an audience details screen configured to display criteria and a number of members for a selected audience, and an audience definition screen configured to allow definition of criteria for forming an audience. The computing system is configured to generate an audience definition based on received criteria, create a plurality of audience segments by identifying user identifiers of potential audience members associated with each criterium of the plurality of criteria based on data obtained from the plurality of data sources, store the audience segments in intermediate storage, formulate the audience based on the audience definition by combining the audience segments into an aggregated collection of user identifiers, and dynamically update the audience according to a defined update frequency.

### BRIEF DESCRIPTION OF THE DRAWINGS

FIG. 1 illustrates an example enterprise network in which aspects of the audience management platform described herein may be implemented.

FIG. 2 illustrates an example architecture of an audience management platform, according to an example embodiment.

FIG. 3 illustrates an example architecture of an audience management platform, according to a second example embodiment.

FIG. 4 illustrates an example audience definition useable to formulate an audience using the audience management platform described herein.

FIG. 5 illustrates a method of enabling access and definition of audiences using an audience management platform, in accordance with example embodiments.

FIG. 6 illustrates a method of joining audiences in an audience management platform, in accordance with example embodiments.

FIG. 7 illustrates a method of periodic audience refresh and maintenance in an audience management platform, in accordance with example embodiments.

FIG. 8 illustrates an example audience join execution flow in an audience management platform, in accordance with example embodiments.

FIG. 9 illustrates an example audience selection screen included in a user interface presented by an audience management platform, in accordance with example embodiments.

FIG. 10 illustrates an example audience details screen included in a user interface presented by an audience management platform, in accordance with example embodiments.

FIG. 11 illustrates an audience definition screen included in a user interface presented by an audience management platform, in accordance with example embodiments.

FIG. 12 illustrates further functionality of audience definition screen included in a user interface presented by an audience management platform, in accordance with example embodiments.

FIG. 13 illustrates further functionality of audience definition screen included in a user interface presented by an audience management platform, in accordance with example embodiments.

FIG. 14 illustrates further functionality of audience definition screen included in a user interface presented by an audience management platform, in accordance with example embodiments.

FIG. 15 illustrates further functionality of audience definition screen included in a user interface presented by an audience management platform, in accordance with example embodiments.

FIG. 16 illustrates an example computing device on which examples of the audience management platform may be implemented.

### DETAILED DESCRIPTION

As briefly described above, embodiments of the present invention are directed to a platform useable for pre-aggregating and maintaining defined audiences. Such audiences may have an affinity toward particular communications, items, or item categories, and may be defined, at least in part, based on behavior models derived from individual user activity.

In example embodiments, the platform described herein is built to leverage a consolidated user dataset in a user data management platform. The platform described herein, which may integrate with or be included within the user data management platform, operates as a centralized location at which audiences may be defined and maintained for a variety of types of enterprise applications, such as sending email communications (e.g., notices, marketing messages and the like), push messages via mobile application, mailers, or other types of applications. Because an enterprise may have a number of user teams seeking to communicate with audiences of users (e.g., retail customers or other types of users interacting with enterprise goods or services), such a platform avoids the requirement of each team to separately build, store, and maintain audience definitions, and allows for reuse across interested users or teams.

In some instances, audiences may be predefined and based on a plurality of criteria. The criteria may be determined criteria obtained from model-based analysis of user behavior, for example, browsing or purchasing behavior on a retail website. Individual model-based analyses may be used to define individual audience segments that may be split and/or combined to form audiences. As such, audience segments may also be precalculated and predetermined to simplify later, custom audience creation.

In some instances, the platform may expose an application programming interface (API) that allows tenant applications to define specifications for audiences and segments using unstructured data objects, such as Javascript Object Notation (JSON) files. User interfaces may be provided that enable definitions of audiences based on available model data and user deterministic criteria, with each criteria being useable to define an audience segment, and the audience segments selectively combined as desired to arrive at audiences. The user interfaces further allow audience creators and users to define refresh frequency of audience members based on the audience definition.

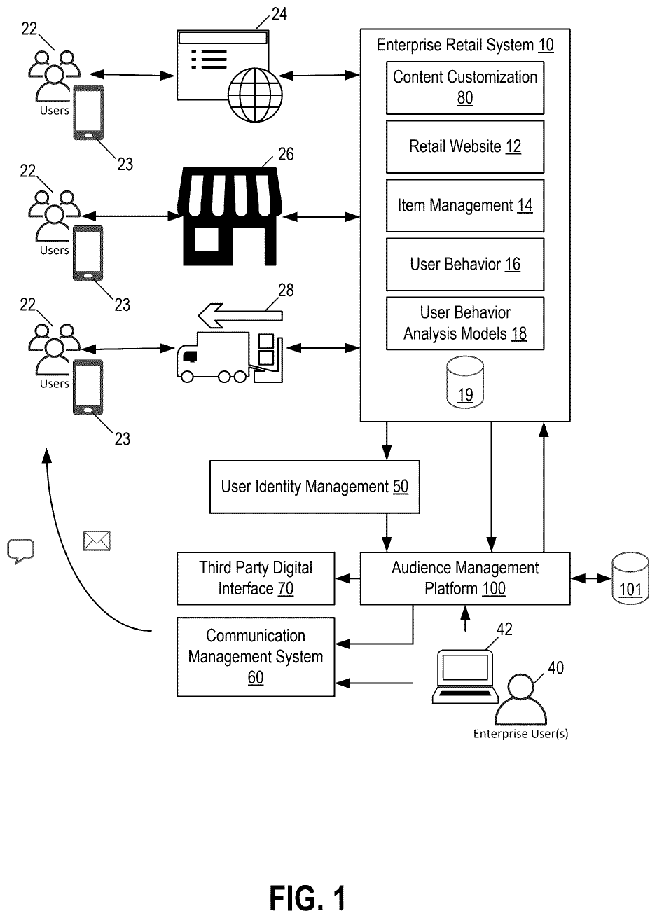

FIG. 1 illustrates an example enterprise network in which aspects of an audience management platform 100 described in the invention can be implemented. Overall, FIG. 1 provides a high-level view of how the audience management platform 100 integrates with other enterprise systems to enable targeted audience pre-aggregation and maintenance. As illustrated, the enterprise network includes an enterprise retail system 10 that includes a retail website 12, an item management system 14, a user behavior management system 16, and a user behavior analysis modeling system 18.

In the example shown, the retail website 12 represents an online presence of an enterprise, and may provide, via web application or mobile application, items or services for sale to users, such as users 22. In example implementations, the retail website may be accessible via webpage 24, for example to order goods or services for pickup at a physical store location 26, or for delivery 28. The user's 22 may access the retail website 12 via various types of personal computing devices 23, such as mobile devices.

In the example shown, the item management system 14 manages inventory levels, product offerings, and the like to be presented to the users 22 via the retail website 12. The users 22 interact with the items, with user interactions stored at the enterprise retail system 10. User interactions may include, for example, selection of individual items on the retail website 12, purchases, page views, and the like.

In examples, user interactions may be captured within a user behavior management system 16. The user interactions may be fed to one or more user behavior analysis models 18, which may be used to infer user preferences associated with particular user identities. Individual user identities may correspond to a user login, a payment method, and email address, and the like. User preferences may be based on past item views or purchases, and may include both stated user preferences and implied user preferences obtained from user behavior analysis models 18. These user preferences may be stored, for example, as affinity data in an affinity database 19.

In the example shown, a user identity management platform 50 may be communicatively connected to the enterprise retail system 10. The user identity management platform resolves user identities to ensure correct, and complete, user identity information gathering, for example to aggregate into a single user identity instances where an individual user may interact with the enterprise retail system 10 in different ways (e.g., providing different payment methods, email addresses or mailing addresses, and the like).

In example implementations, user identities may be obtained from the user identity management platform 50 in a number of ways. A user profile identity may be used in some cases, which corresponds to a particular manner in which a user identifies himself or herself. A user profile identity may correspond, for example, to an email or physical address, a particular payment method, or the like. In other examples, a user cluster identity may be requested for use. A user cluster identity may correspond to an identifier associated with one or more user profiles that all are determined likely to correspond to a common user, e.g., based on commonality criteria determined by the user identity management system. The commonality criteria may be common data attributes (e.g., a common address, name, email address, or the like) or may be based on inferred similarity of two user profiles. In addition, an email identity may be selected which may correspond to either a user profile identity or a user cluster identity, but may only relate to user identities managed by the identity management platform 50 in which an email address is included.

Further details regarding user clustering, and operation of the user identity management platform 50, are provided in copending U.S. patent application Ser. No. 18/097,971, entitled “Management and Determination of User Identity Using Identity Graphs”, the disclosure of which is hereby incorporated by reference in its entirety.

In the example shown, an enterprise user 40 may interact with an audience management platform 100 via an enterprise computing device 42. The audience management platform 100 is communicatively connected to the enterprise retail system 10, the user identity management platform, and a communication management system 60, described below. The enterprise user may generally be any user who is seeking to create or use an audience having particular characteristics, drawn from among the users 22 and based on the manner in which they might interact with the enterprise retail system 10.

In the example shown, the audience management platform 100 enables definition of audiences which may be stored in an audience database 101, based on user behavior determined by the user behavior management system 16, inferred user preferences obtained by the user behavior analysis models 18, affinity data stored in the affinity database 19, and deterministic characteristics of users as captured within the user identity management platform 50. Details regarding audience definition and audience formation are provided further below. In general, the audience management platform 100 may be configured to construct custom audiences, formed from a plurality of user identifiers of various types, based on an audience definition defining the characteristics of a desired audience. The audience management platform 100 may do so by using pre-aggregated audience segments or custom audience segment definitions that are aggregated at user definable intervals.

In example implementations, created audiences formed by the audience management platform 100 may also be stored and exported to consuming applications, such as the communication management system 60, a third party digital interface 70, and/or content customization systems 80 incorporated into the enterprise retail system. In the example shown, the communication management system 60 generates and sends communications to one or more of the users 22 via configurable, customizable delivery means such as email, text or mobile application notifications, and the like. In some implementations, a third party digital interface 70 may determine external user identifiers that correspond to the user identifiers that are used to define an audience, for purposes of external targeted messaging. Still further, identified audiences may be targeted with customized content by the enterprise retail system 10, e.g., via content customization system 80, e.g., to deliver customized content to specific identified audiences.

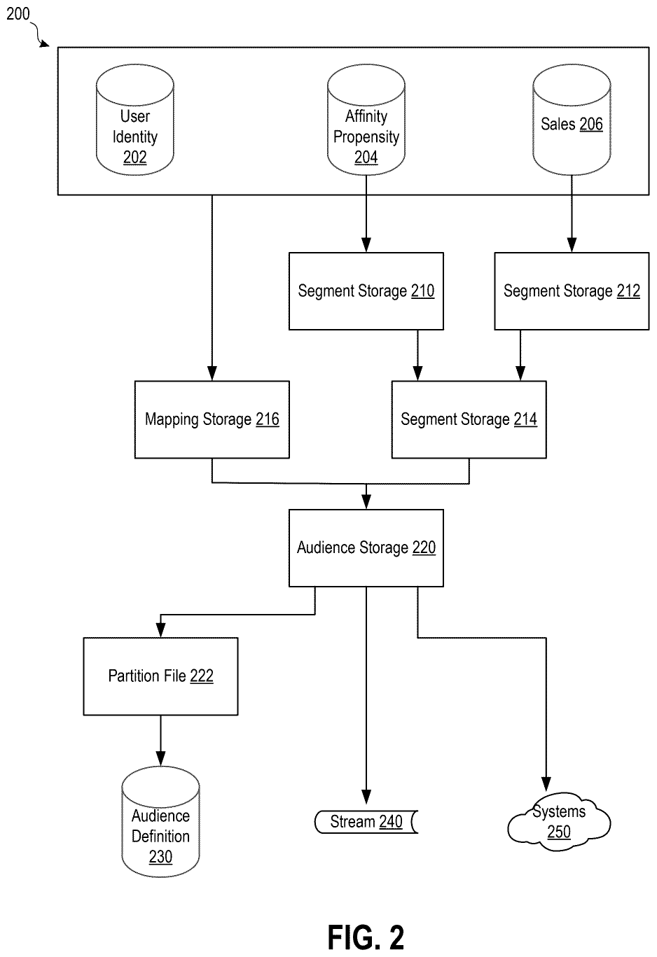

FIG. 2 illustrates the architecture of an audience management platform 200, according to an example aspect. The audience management platform 200 may illustrate one method of implementing the audience management platform 100 of FIG. 1.

The architecture shown in FIG. 2 illustrates how an audience management platform integrates various data sources and storage components to enable the creation, storage, and management of audience segments and definitions. As illustrated, the audience management platform 200 operates to aggregate data from multiple sources (e.g., user identity, affinity propensity, and sales) to create targeted audiences based on defined criteria.

As illustrated, the audience management platform 200 is configured to pre-aggregate and maintain audiences and/or audience segments, allowing for quick formation of custom audiences and providing information about audience sizes to users of the platform. The users of the platform may correspond, for example, to enterprise users 40 of FIG. 1, for example employees or teams within the enterprise who create and manage audiences.

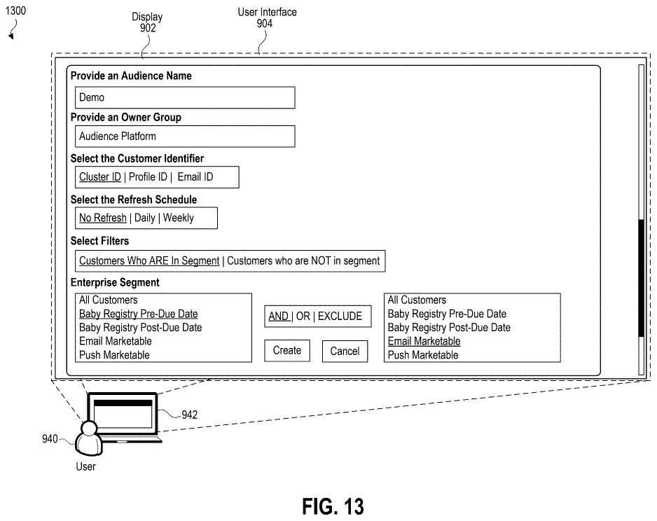

In the example shown, a set of data sources are available to the audience management platform, including user identity data 202, affinity propensity data 204, and sales data 206. The user identity data 202 may include information about users known to the enterprise, and may correspond to user identities managed by the user identity management platform 50. As such, user identities take the form of user identifiers that may correspond to a profile, an email address, or a cluster of profiles understood by the enterprise to correspond to a common user. The affinity propensity data 204 may be data output from one or more user behavior analysis models 18, and stored in affinity database 19. The affinity propensity data may include, for example, data describing specific affinity to individual items or item types based on purchasing or browsing behavior, affinity to particular usage modes (e.g., delivery channels), and the like. Generally speaking, the sales data 206 and the user identity data 202 correspond to known attributes of users or deterministic characteristics of user actions (e.g., “has purchased X item in the last 30 days” or the like), while the affinity propensity data 204 corresponds to inferred attributes of users determined from behavioral models (e.g., “having an affinity for bananas above a predetermined affinity threshold” or “possible women's active apparel shopper above a predetermined threshold likelihood score” or the like). As illustrated below, audience segments may be defined using such deterministic characteristics of users (e.g., communication channel preferences, membership in particular programs such as loyalty or registry programs, and the like) or using inferential characteristics determined from propensity data (e.g., propensity to purchase particular goods, and the like). Details regarding definition of such audience segments are provided below in conjunction with FIGS. 13-15.

In the example shown, a definition of user characteristics may be used to create audience segments. In this example illustration, a plurality of segment storage components 210, 212, 214 are illustrated. The segment storage components may receive a listing of user identifiers (e.g., from among the types of user identifiers described above) that show aggregations of user identifiers based on individual segments identified in the sales data and affinity data. Each segment storage component may store a listing of individual users who qualify as members of an audience segment, e.g., by cluster identifier or profile identifier. Additionally, mapping storage 216 provides storage of associations between user identifiers obtained from the user identity management system and criteria data obtained from the sales data and affinity data as described above.

In the example shown, an audience storage component 220 stores merged user identifiers obtained from the segment storage components 210, 212, 214, as referenced by the specific mapping storage 216, to arrive at a resolved set of user identifiers that correspond to the audience definition. The user identifiers that are aggregated at the audience storage component 220, which stores the user identifiers (e.g. cluster identifiers, profile identifiers, etc.), as well as a timestamp for when the audience is created and an audience identifier. The audience as defined in the audience storage component 220 may then be provided to an audience definition database 230 (e.g., via a partition file 222, useable for efficient data organization and retrieval), a stream 240 such as a Kafka topic or other streaming output that may be ingested by another device or service, or external systems 250, such as may be hosted within an enterprise cloud environment.

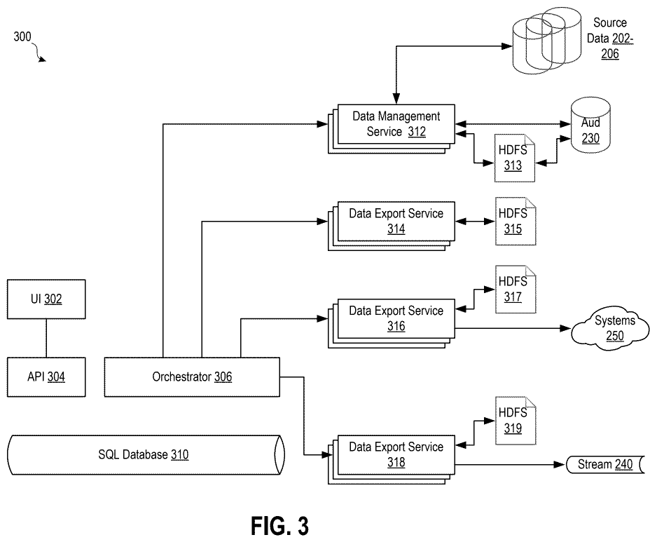

FIG. 3 illustrates another example architecture of an audience management platform 300 described in the invention. The audience management platform 300 represents an implementation of platform 100 of FIG. 1, described above. In the example shown, the audience management platform 300 illustrates data management and export services using distributed storage systems to process and store large amounts of audience data, including both user interface and application programming interface (API) based access thereto.

As illustrated, FIG. 3 highlights the capability of the audience management platform 300 to pre-aggregate and maintain audiences by efficiently processing data from multiple sources, storing it in distributed systems, and providing various methods for accessing and exporting the resulting audience data.

In the example shown, the audience management platform accesses source data 202-206, corresponding, for example, to the user identity, affinity propensity, and sales data as seen in FIG. 2. The platform 300 exposes a user interface 302 and application programming interface (API) 304. The user interface 302 is accessible by enabled enterprise users, such as enterprise user 40, to define and access audiences. The API 304 is accessible by users and/or enterprise applications to request predefined audiences, or in some instances, submit audience definitions for generation of audiences.

In the example shown, the audience management platform 300 includes an orchestrator 306 that manages creation of audience segments and audiences based on received requests, as well as managing the refresh of audiences on schedules defined in each audience definition. The orchestrator 306 periodically examines the audience, segment, and mapping definitions defined in the individual segments described below to determine if new audiences, segments, or mappings need to be created. The orchestrator 306 may access data in SQL database 310, for example previously-created audience definitions, and use one or more data management and/or data export services 312, 314, 316, 318 to interact with external data sources to create audiences based on the received audience definitions. The SQL database 310, thus, stores various processing including definitions of segments to be created, timing of refresh of audiences, and the like. Accordingly, users may access pre-defined segments for combination and use, thereby simplifying the creation of new audience definitions.

When new audiences are created, as noted above, preexisting audiences may be used as a starting point. It is noted that different audiences may be constructed using different types of audience identifiers; in examples, the orchestrator may operate to resolve identifier types. For example, if one audience uses a user cluster identifier and another audience is constructed using user profile identifiers, a new audience may be created from those two audiences by using user profile identifiers, with the user cluster identifiers automatically resolved as each corresponding to one or more user profile identifiers (based on the number of user profiles associated with a given user cluster). Additionally, audience segments may be automatically joined together in a variety of ways either at execution time or a time of definition. Finally, each audience segment may be defined as having a particular refresh timing of the audience members based on the definition of the audience; in some instances, the audience or audience segment may be deemed stale or out of date if it has not been either refreshed or used within a predetermined period of time, and therefore may be deleted and/or removed from being available to be used in constructing new audiences.

In the example shown, a data management service 312 provides an interface to external source data 202-206, and storage of audiences created using the source data in an audience database 230. An HDFS component 313 enables storage and processing of aggregated audience data defined by audience definitions included in the audience database 230. The audience database 230 may store audience definition objects, e.g., in the form of JSON objects, for retrieval and use. The HDFS component 313 therefore provides bulk storage of audience identifiers as may be quickly retrieved for use when desired, e.g., as requested via the API 304.

In addition to the above, a plurality of data export services 314, 316, 318 are interfaced by orchestrator 306 for export of audience data in response to requests. Data export service 314 manages output of audience data to HDFS component 315 for bulk audience storage in, e.g., a Hadoop file storage cluster. Data export service 316 enables receipt of data from HDFS storage component 317, and for publishing of audiences to external systems 250. Data export service 318 manages receipt of data from HDFM storage component 319, and output to streaming data service 240.

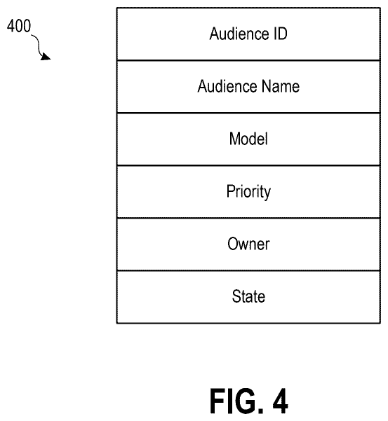

FIG. 4 illustrates an exemplary structure of an audience definition 400 as utilized within the audience management platform described in the invention. This structure offers a standardized schema for storing essential information pertaining to each audience. This allows for easy reference, efficient management, and streamlined processing of audience data. The audience definition may be stored in a table within an audience definition database, and may include, for example, an audience identifier, an audience name, a model, a priority, an owner, and a state field.

In the example shown, the audience identifier serves as a unique identifier for each audience, ensuring distinctiveness and traceability within the platform. Additionally, the audience name provides a descriptive title for the audience, facilitating easy identification and reference by users. The model designator refers to the behavioral model or criteria employed to define the audience. This may encompass algorithms, heuristics, or predefined rules characterizing the audience's behavior and attributes. A priority field indicates the importance or the sequence of processing designated for the audience, which can be determined based on various factors, including but not limited to, strategic significance or urgency. An owner field designates the entity, team, or individual responsible for the creation, management, and oversight of the audience definition, ensuring accountability and promoting collaboration within the enterprise. Additionally, the state field represents the current status of the audience, which may include states such as active, inactive, pending, or any other relevant operational condition.

The structured audience definitions enable pre-aggregating and maintaining audience data, by ensuring efficient creation, retrieval, and updating of audience information based on the specified criteria, thereby optimizing the overall operational workflow within the platform.

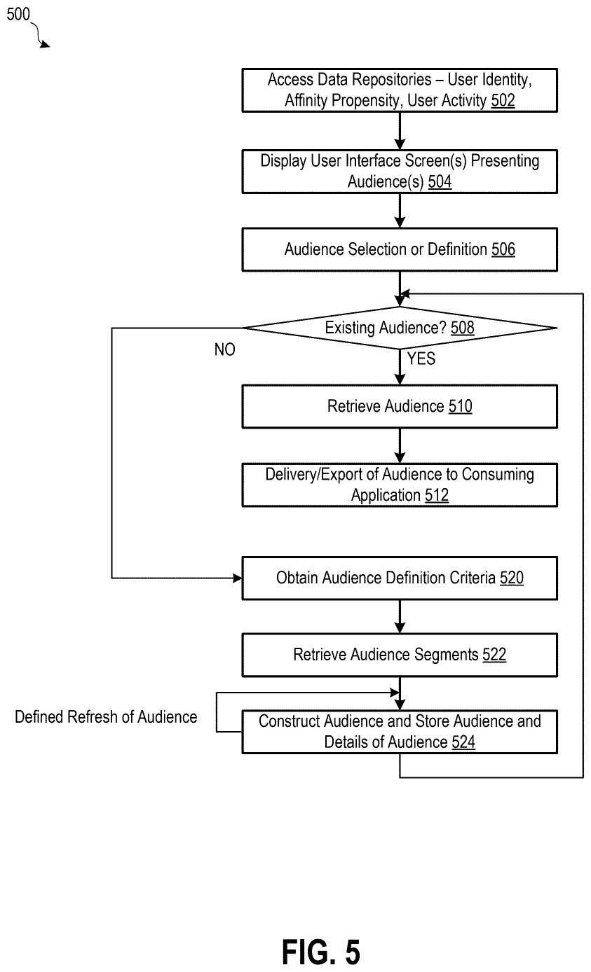

FIG. 5 illustrates a flowchart of a method 500 for enabling access and definition of audiences using the audience management platform described in the invention. The method may be performed, for example, using the audience management platforms 100-300 of FIGS. 1-3, above. This flowchart illustrates both access to existing predefined audiences and creation of new custom audiences based on user-defined criteria. It also shows how the platform integrates with data repositories and consuming applications, supporting pre-aggregating and maintaining targeted audiences for various enterprise uses.

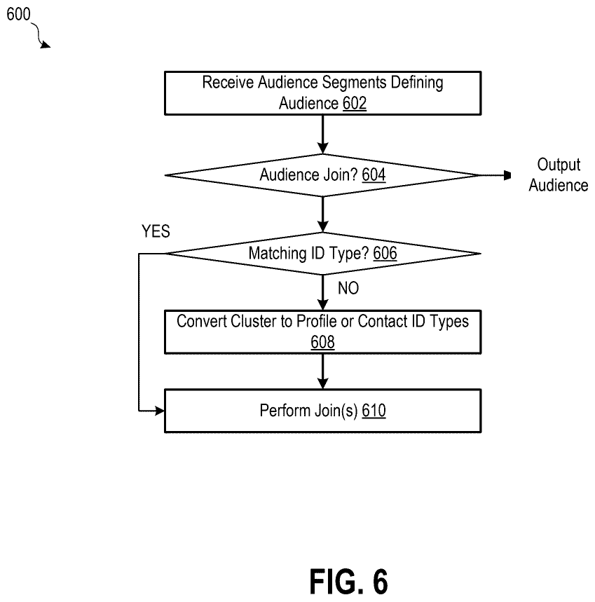

In the example shown, the method 500 includes accessing data repositories (step 502). This may include, for example, access to various enterprise data repositories, including user identity, affinity propensity, and user activity databases, such as sales databases, loyalty databases, browse activity databases, engagement databases, and the like. The method 500 further includes displaying a user interface screen to a user (step 504). The user may be an enterprise user 40, using an enterprise computing system 42, and the user interface screens may be generated and presented by the audience management platforms described herein. The user interface screens may include those illustrated below in conjunction with FIGS. 6-12. That is, the user interface may present preexisting audiences, and/or may present one or more user interfaces for generating new audiences.

In the example shown, the method 500 further includes receiving a selection or definition of an audience (step 506). This may include a user selecting an existing audience (e.g., at an audience selection screen of a user interface) or defining a new audience (e.g., at one or more audience definition screens). If the user selects an existing audience, operational flow proceeds from decision point 508 to retrieval of the existing audience (step 510), with return of that audience to the user for use. The return of an audience may be delivery to a desired platform or application for use. The audience as returned may include, for example, a collection of user identifiers of various types (e.g., cluster identifiers, profile identifiers, or email identifiers) depending on the audience definition, and may be delivered back to the user or may be provided to an indicated consumer of the audience. In some instances, the user may define an audience using the user interfaces described herein, while previously-defined audiences may be retrieved either via the user interface or via an API as described above. Regardless of the manner of delivery, the audience may be delivered and/or exported to a consuming application or platform (step 512).

If, at operation 508, it is determined that a new audience is to be defined, the method 500 includes collecting one or more criteria useable to form an audience definition (step 520). The criteria may include deterministic or modeled, inferred criteria, geographic location, behavioral data (e.g., browsing and/or purchasing history, engagement metrics), affinity and propensity scores (e.g., likelihood to purchase a particular good or service, affinity towards particular brands and/or categories), user activity data, custom attributes, temporal factors (e.g., recency of interactions, seasonality, and the like), transaction data (e.g., average purchase value and frequency), engagement data (e.g., rate of interaction with communications or marketing campaigns), and the like. In accordance with usage of the audience definition screens described below, the entered criteria can be combined and weighted according to specific business goals to define a targeted audience.

In the example shown, the method 500 further includes retrieval of relevant audience segments (step 522). In example implementations, this includes either forming new audience segments, or obtaining audience segments pre-stored from storage in response to selection of those audience segments based on their inclusion in an audience definition. In the event of pre-stored audience segments, retrieval of audience segments may include obtaining a collection of user identifiers that are included in a given audience segment, from pre-stored segment data (e.g., in HDFS components as described above in conjunction with FIGS. 2-3).

In the example shown, the method 500 further includes construction and storage of the audience (step 524). This includes, once audience segments are retrieved, forming an overall audience based on logical combinations of those audience segments. Logical combinations of audience segments may include combinations of segments using logical operators, such as AND, OR, NOT, and the like. Once an audience is constructed by logically combining selected audience segments, the audience may also be stored, for example in a large storage such as a Hadoop data storage cluster. Furthermore, the audience may be defined to be refreshed, for example based on revision or recreation of the audience from induvial refreshed segments, at defined refresh rate of the audience.

It is noted that although a user may define the frequency of refresh of the audience, refresh of the membership of users within each audience segment may be handled independently of refresh of the audience. For example, while an audience definition may indicate that an audience is a one-time audience and is not refreshed, individual segments of the audience may be refreshed. Accordingly, if an enterprise user wishes to later change the refresh rate of the audience, the individual segments are already refreshed on an independent cadence (e.g., daily or weekly) and ready for efficient refresh of audience members in the audience.

FIG. 6 illustrates a method 600 of joining audiences in an audience management platform. The method may be performed using the audience management platforms described above. Generally speaking, various types of joins of audiences or audience segments may be performed. Such joins may be made in-memory within the audience management platform described above in conjunction with FIGS. 1-2. Such joins may be flexibly performed between audiences constructed from definitions of users, and may include, e.g., unions (the inclusion of all audience members from two audiences being joined), intersections (only those audience members that overlap between two audiences), differences (only those audience members of one audience that are not in the other audience) or subsets of a particularized audience (e.g., a top X % of a given audience). Combinations of these joins may be performed to achieve complex audience definitions.

Additionally, and as noted above, each created audience or audience segment may have a particularized refresh timing and expiration. A refresh timing may refer to the fact that a particular audience is reconstituted from audience members at a particular rate (e.g., weekly or monthly) as audience members change, and are added to or exit a particular audience definition. By example, members of an audience focusing on active gift registries is likely to change greatly between months, so might be selected to refresh more quickly, while and audience focusing on regularized grocery shopping or card holders might not need to be refreshed as quickly due to the less transient nature of that audience. By further example, a particular audience created for a one-time event or rare event during a year (e.g., back to school sales, or the like) might be set to expire a few months after creation, while retail payment card holder audiences would likely have more relevance over a longer time period so may not have an expiration date assigned.

Still further, as noted above, audiences may be constructed from different types of user information. As described in copending U.S. patent application Ser. No. 18/097,971, a user structure may include a cluster of identifiers that represent a user. Alternatively (and additionally) each identifier may correspond to a different profile; such profiles may be based on a customer's email address, or payment method, or the like. Each profile may identify the user differently, and may represent a different way in which the user interacts with the organization (e.g., by logging in to a website using an email address, by purchasing items in-store with a particular payment method, etc.). Each of the profiles may be included in a cluster, and in some cases, fewer or more of the profiles may be considered as part of the overall cluster depending on a confidence determination that the profile in fact represents the same user. Given these different structures and variable inclusion of profiles into a cluster, performing the various joins between disparate audiences can be complex, since some audiences may be more out of date than others, and may use different ways of identifying users.

In this context, the method 600 provides a way of performing in-memory joins of audiences or audience segments by ensuring that only valid audiences are joined, and that joins are performed on compatible identifiers of users. In the specific example shown, the method 600 includes receiving audience segments defining an audience (step 602). The audience segments may be retrieved from storage or newly created based on defined criteria, and may include two or more audience segments to be joined.

At decision point 604, the method includes determining if an audience join is to be performed. If no join is needed, the audience may be output directly. If a join is needed, at decision point 606 the method determines if the audience segments to be joined use matching ID types. For example, matching ID types may correspond to two audience segments using profile IDs to identify users. Mismatching ID types may correspond to one audience segment using a profile ID or a contact ID, while the other audience segment subject to the join might use a cluster ID (which may include more than one profile within that cluster).

If the ID types do not match, the method includes converting the cluster IDs to profile or contact ID types (step 608). This conversion enables joining of audiences that use different identifier types. For example, if one audience uses cluster identifiers and another uses profile identifiers, the cluster identifiers are converted to corresponding profile identifiers to enable the join operation. This involves identifying each profile ID included in the cluster corresponding to the cluster ID, and including each of those profile IDs in an intermediate, converted audience used in the join operation(s). This conversion from cluster to profile IDs includes all profiles associated with each cluster, not just the primary profile, to ensure maximum matching potential when performing join operations.

The method then performs the requested join operations (step 610). As noted above, join operations may include unions, intersections, or differences between audience segments. The join operation uses an efficient binary search algorithm, where one audience's identifiers are loaded into memory and sorted to enable fast lookups when processing the other audience's identifiers. The join operation preserves the ordering of the first audience being processed. In particular, in example implementations, a binary search join algorithm first loads one audience's IDs into a memory buffer and sorts those IDs to enable efficient lookups when processing the second audience's IDs. Because audiences may have an intrinsic ordering based on criteria like affinity scores or other metrics, preservation of this ordering is advantageous in that ordering is preserved that can be used for subsequent operations, e.g., selecting top N members of an audience.

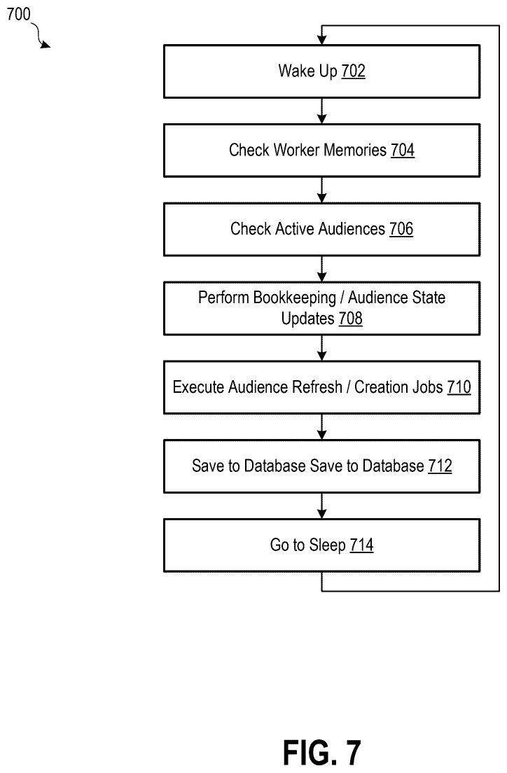

FIG. 7 illustrates a method 700 of periodic audience refresh and maintenance in an audience management platform. The method may be performed using the orchestrator component of the audience management platforms described above. The audience refresh and maintenance may be performed periodically by the orchestrator, which generally may operate to periodically assess which, if any, defined audiences are scheduled for refresh and/or expiration, and will update audiences in accordance with those defined characteristics.

In the example shown, the method 700 includes a periodic wake up operation (step 702) in which the orchestrator initiates a refresh cycle. In example implementations, the orchestrator wakes up at configurable periodic intervals (e.g., every 30 seconds) to check status and submit new jobs. The orchestrator operates in a stateless manner, with all state information stored in a database rather than memory. Because the orchestrator is stateless it rebuilds its entire state from the database on each wake cycle, making it robust to restarts and failures.

Upon waking, the method includes checking worker memories (step 704) to determine current job status and available capacity of worker services. Such workers may include e.g., the services 312-318 described above in conjunction with FIG. 3, and may be performed on separate computing systems as compared to the orchestrator itself and each other, thereby ensuring computational capacity and separating the data processing and orchestration aspects of audience maintenance. In this context, the orchestrator queries each worker service to determine how many jobs are currently being processed, as well as available capacity to process additional work.

The method further includes checking active audiences (step 706) by querying a database (e.g., audience database 230) to identify which audiences are currently active and require processing. The orchestrator retrieves execution plans and current states for all active audiences. The query of the audience database retrieves the specific timing of audience refresh and audience characteristics of each of the audiences being maintained.

The method then performs bookkeeping and audience state updates (step 708), including matching ongoing jobs with execution plans and updating completion status of tasks. This information is used to determine what additional processing may be needed.

Based on the current state and available worker capacity, the method executes audience refresh and creation jobs (step 710). The orchestrator intelligently submits new jobs to workers based on their current load to prevent resource overloading.

The method includes saving state updates to the database (step 712) before returning to sleep (step 714). This ensures all processing status is preserved externally from the orchestrator, enabling robust operation and visibility into audience processing status.

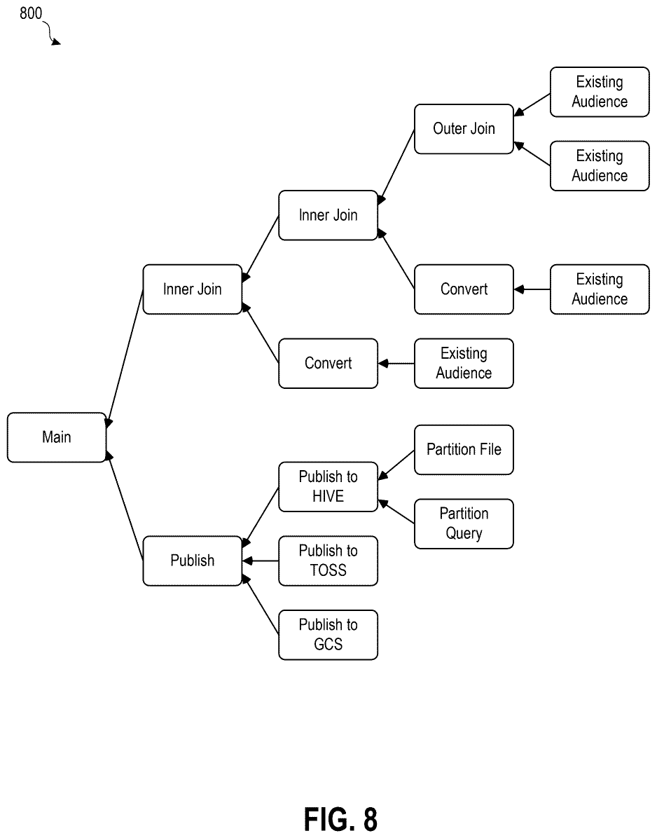

FIG. 8 illustrates an example audience join execution flow 800 in an audience management platform. The execution flow represents how complex audience operations are broken down into discrete tasks that can be processed efficiently by worker services, for example, to be executed using the methods described above in conjunction with FIGS. 6-7.

The execution flow is represented as a tree structure where each node represents a specific task in the audience creation or maintenance process. The tree structure enables concurrent execution of independent tasks while enforcing sequential execution where dependencies exist. Each task in the execution tree may be assigned a unique tracking ID that can be used to retrieve detailed logs about execution of that task.

In the example shown, the execution flow includes multiple join operations, with inner and outer joins being performed on existing audiences. The flow also includes conversion operations where audience identifier types are transformed to enable proper joining. Such processes may be performed in conjunction with the methodology described above, with respect to FIG. 6.

The execution flow further includes multiple publish operations, including publishing to various storage systems such as HIVE (a database system), TOSS, and Google Cloud Services (GCS). These publish operations must occur after their dependent join operations are complete.

The execution flow is stored as a JSON document in a database, enabling external applications to monitor processing progress without directly querying the orchestrator. The JSON document may include details such as, e.g., attributes for each node indicating task status, start time, completion status, and progress. This provides greater visibility into audience processing status and supports diagnostic capabilities.

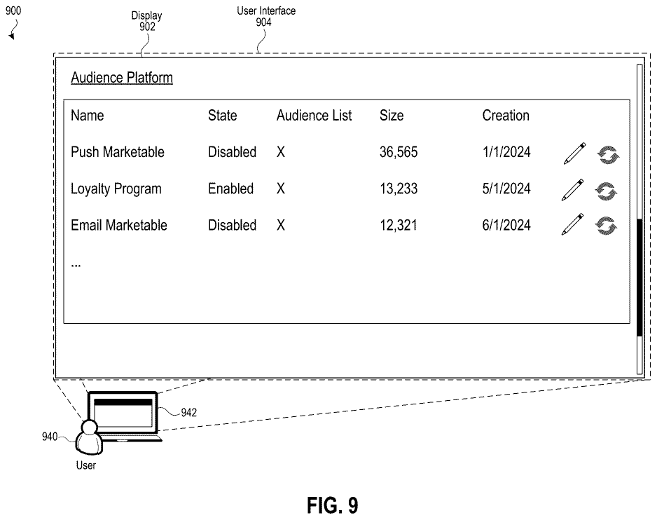

Referring to FIGS. 9-15, screens are illustrated that may be presented in a user interface 904 presented on a screen 902. The screen 902 may be presented on a computing device 942, such as may be used by a user 940. The user 940 and computing device 942 may be examples of the enterprise user 40, and enterprise computing device 42 described above in conjunction with FIG. 1.

FIG. 9 illustrates an example audience selection screen 900 useable in example embodiments of the present disclosure. The audience selection screen 900 allows users to select from among a plurality of predefined audiences, providing an overview of available audiences, their current state, size, and creation date, thereby facilitating easy management and selection of audiences for various enterprise applications such as email communications, push messages, or other types of applications.

In the example shown, an audience list is displayed that includes a list of predefined audiences, including names such as “Push Marketable,” “Loyalty Program,” and “Email Marketable.” The list includes details for each predefined audience, including a name, state (e.g., enabled or disabled), size (number of audience members), and creation date of each audience. This enables users to readily see the size of an audience prior to selection (e.g., to control the breadth of distribution of communication to a given audience). In examples, ability to enable or disable individual audiences provides flexibility in audience management.

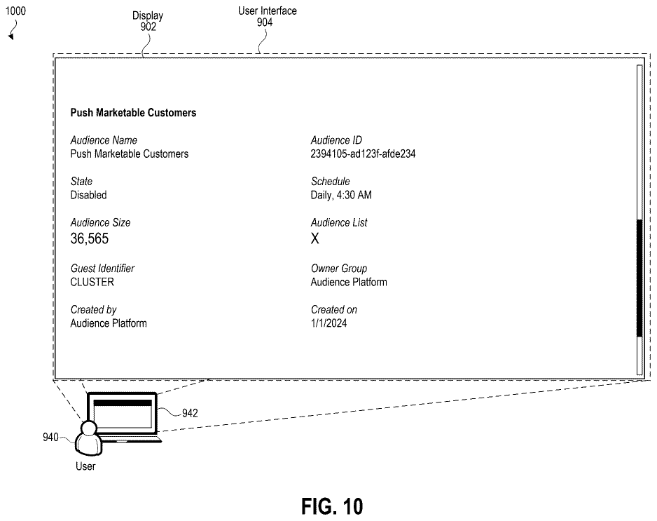

FIG. 10 illustrates an example audience definition screen 1000 included in the user interface 904 presented by the audience management platform, as described above. The audience definition screen includes a plurality of audience definition fields including an audience name field as well as a plurality of audience details fields, including a state field indicating the enabled/disabled state of the audience, an audience size field indicating a number of audience members included in the audience, a customer identifier field indicating the type of identifier of an audience member being used (in this case a cluster identifier), a creator identity, and a unique audience identifier. The audience definition fields include a schedule describing the refresh frequency of the audience, as well as a creation date and an owner group.

Overall, the audience details screen 1000 provides a comprehensive view of the audience characteristics and allows for the modification or refinement of the audience definition once created. The audience details screen 1000 might be presented in response to selection of a particular audience in the audience selection screen 900 of FIG. 9.

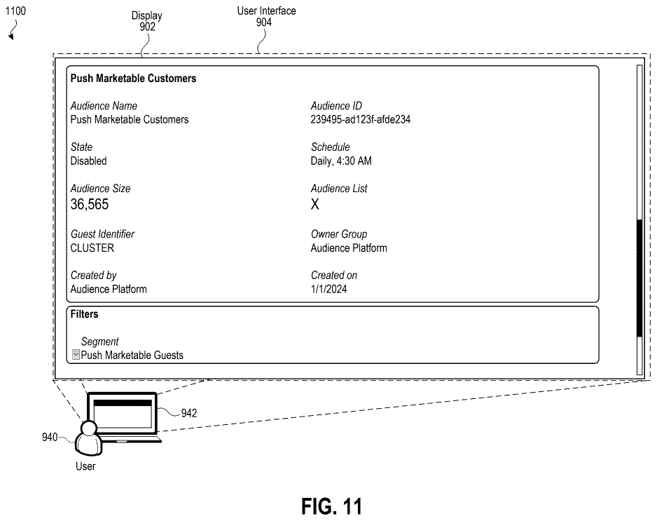

FIG. 11 illustrates a further version of an audience details screen 1100. The audience details screen 1100 includes the general details described above in conjunction with FIG. 10, but further includes a filters region in which a user may select a particular filtering criteria that may be used. In the example shown, a plurality of selectable, configurable options are provided, and useable to select criteria useable to define the audience. As illustrated, a drop-down menu is provided that allows a user to select a particular pre-defined audience segment to be included in the audience. As illustrated, the selected segment corresponds to “push marketable customers”; however, any other predefined audience segment may be selected as well, and are made available based on configuration in the audience management platform (e.g., within the SQL database 310 of FIG. 3). Although a single filter is shown, it is recognized that a plurality of filters may be used and combined in custom ways to obtain a desired audience.

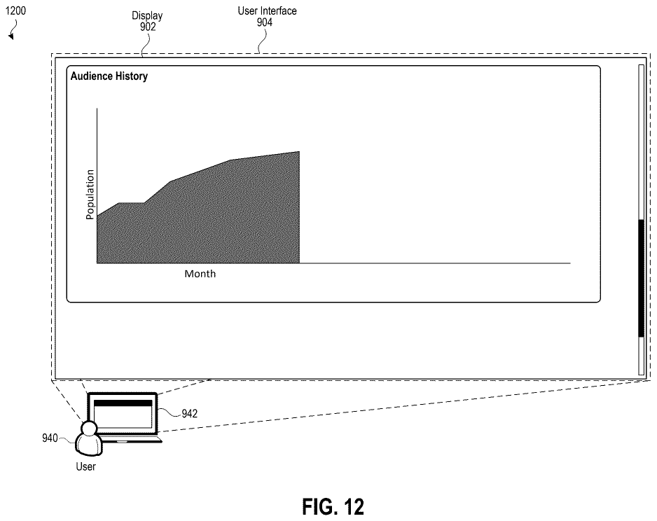

FIG. 12 illustrates a further example of an audience details screen 1200. The audience details screen 1200 may be an additional, separate screen as compared to screens 700, 1100 of FIGS. 10-11, or a continuation thereof (e.g., by scrolling through the same screen). That is, the audience details screen 1200 is specific to a particular, selected audience, similar to those screens.

In this example, a historical audience population graph is depicted. The graph illustrates a number of audience members over time, thereby allowing a user to see how a number of users who meet the selected audience criteria may change over time. This allows a user to quickly see whether the audience definition remains appropriate or whether the audience population needs adjustment (e.g., by adjusting criteria). The change in audience population may adjust in accordance with a refresh frequency of the audience.

Overall, the audience details screen 1200 enables enterprise users to track the evolution of their audiences, potentially showing how audience sizes or compositions change over time. This functionality supports the overall features of the platform in maintaining up-to-date and relevant audiences for various communication and marketing purposes.

FIGS. 13-15 illustrate audience definition screens that may be useable by an enterprise user 940 via a computing device 942 to create an audience definition that may be utilized to form a specific audience. It is noted that although audience definition is described in conjunction with use of a user interface, it is recognized that a user may similarly submit an audience definition including similar data elements via an application programming interface (API) as described above.

FIG. 13 illustrates an example of an audience definition screen 1300 included in the user interface 904 presented by the audience management platform as described herein.

The audience definition screen includes an audience name field that receives a user entered audience name (e.g., “Demo”). An owner group field allows a user to provide an owner group of the audience (e.g., enterprise users who have rights to edit the audience definition, including selected criteria, etc. used to form the audience).

In the example shown, a customer identifier type selector is also included. The customer identifier type selector allows a user to select from among a cluster identifier, a profile identifier, or an email identifier, for example. Based on the selection, a different type of user identifier may be returned for use (e.g., as are maintained in the useridentity platform described above).

In the example shown, a refresh schedule selector is also included. The refresh schedule selector allows for disabling any audience refresh, or to perform daily or weekly audience refreshes. This allows recreation of an audience in accordance with the selected schedule, allowing the particular user identities included in the audience to be updated at a configurable cadence.

Additionally, one or more segment selectors are presented alongside filters and logical operators. A user may select from among predetermined audience segments, and combine those segments using logical operators (inclusion/exclusion using filters “Customers Who ARE In Segment|Customers who are NOT in segment”) and logical operators for combination thereof (operators AND, OR, EXCLUDE). Various predefined segments, corresponding to deterministic criteria known to be associated with particular users can be presented (e.g., “All Customers”, “Baby Registry Pre-Due Date”, “Baby Registry Post-Due Date”, “Email Marketable”, and “Push Marketable” as illustrated).

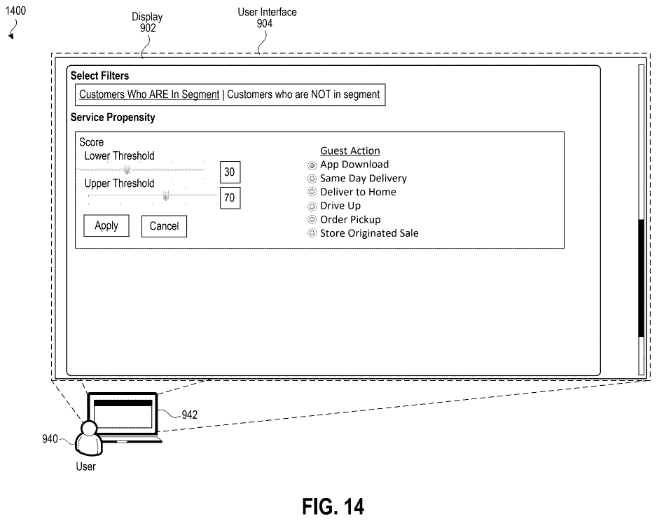

In addition to the segment types selectable in FIG. 13, FIG. 14 illustrates a further example version of an audience definition screen 1400 in the user interface 904. In this instance, the filters may be used to set inferred criteria that may be set based on predictive models managed within the enterprise. In this example, the same logical operators for inclusion, exclusion, and combination of audience segments may be used, but in this instance, are used with audience segments that are based on custom-definable thresholds for confidence in affinity with particular criteria. For example, an affinity to a particular item or class of items, defined by propensity to purchase such items, may be selected by a user, in the form of minimum and maximum propensity scores. The ability to set score thresholds allows for fine-tuned audience targeting based on predicted user behavior.

Additionally, other types of audience definition parameters may be used as well. For example, as illustrated in the audience definition screen 1400, an enterprise audience segment may be defined based on the manner in which the user has elected past interactions, including communications from the enterprise and manner of receiving items purchased from the enterprise. For example, users who have downloaded a mobile application, requested same-day delivery or home delivery of items, requested drive-up pickup of items or in-store pickup of items, or who have purchased items in-store may be sub-segmented. These may be either determined deterministically by past behavior or may be predictive in terms of propensity for use (e.g., based on the affinity data received at the audience management platform).

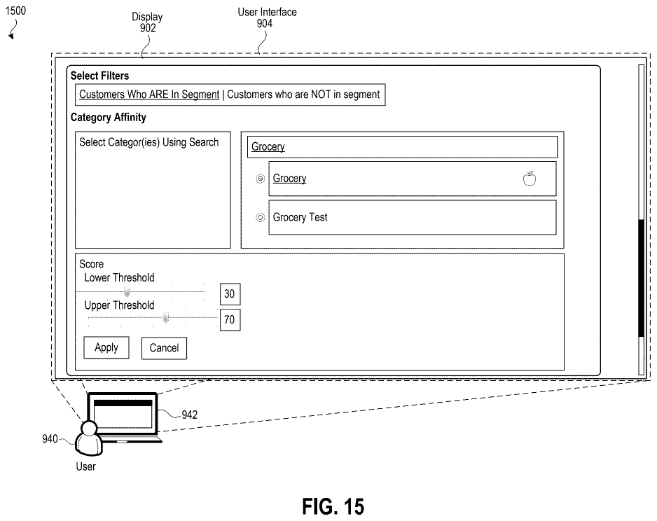

FIG. 15 illustrates another aspect of the audience definition screen 1500 in the user interface 904 presented by the audience management platform. In this example, a particular category affinity audience segment may be selected and defined. In this example, a user may select a particular category (e.g., “Grocery”, “Apparel”, etc.) and define a score range that identifies lower and upper thresholds for affinity scores of users who meet the specified criteria. As with other example criteria, these inferred criteria may be used to include or exclude users, and may be used in combination with other inferred or deterministic criterial to define an audience from discrete, pre-defined audience segments. The ability to search for and select specific product categories allows for fine-tuned audience targeting based on user preferences and shopping behavior. Accordingly use of affinity and propensity data and user activity data allows for creation of sophisticated audience segments from predefined audience segment and affinity data.

Referring to FIGS. 9-15 generally, the user interfaces described herein (and equivalent API functionality) provides enterprise users with tools to create custom audiences based on user affinity towards specific product categories, supporting the platform's capability to pre-aggregate and maintain targeted audiences for retail-oriented marketing and communication efforts. Such pre-aggregation ensures prompt accessibility of complex, defined audiences driven from both deterministic and inferred characteristics, and exposure of such audiences to a wide group of enterprise users from a centralized platform, with flexible accessibility mechanisms enabled for those enterprise users.

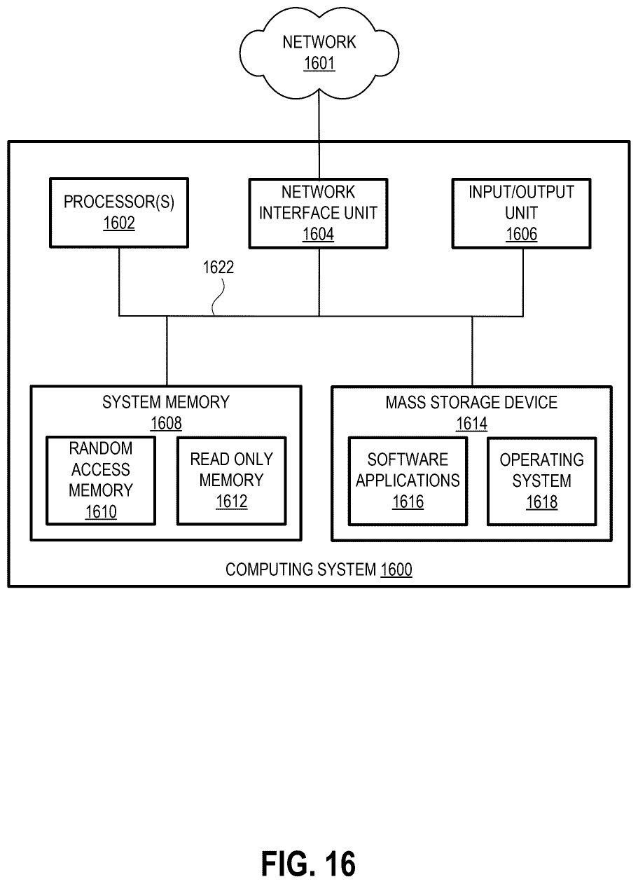

FIG. 16 illustrates an example block diagram of a virtual or physical computing system 1600. One or more aspects of the computing system 1600 can be used to implement the systems described herein, store instructions described herein, and perform operations described herein.

In the embodiment shown, the computing system 1600 includes one or more processors 1602, a system memory 1608, and a system bus 1622 that couples the system memory 1608 to the one or more processors 1602. The system memory 1608 includes RAM (Random Access Memory) 1610 and ROM (Read-Only Memory) 1612. A basic input/output system that contains the basic routines that help to transfer information between elements within the computing system 1600, such as during startup, is stored in the ROM 1612. The computing system 1600 further includes a mass storage device 1614. The mass storage device 1614 is able to store software instructions and data. The one or more processors 1602 can be one or more central processing units or other processors.

The mass storage device 1614 is connected to the one or more processors 1602 through a mass storage controller (not shown) connected to the system bus 1622. The mass storage device 1614 and its associated computer-readable data storage media provide non-volatile, non-transitory storage for the computing system 1600. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1600.

According to various embodiments of the invention, the computing system 1600 may operate in a networked environment using logical connections to remote network devices through the network 1601. The network 1601 is a computer network, such as an enterprise intranet and/or the Internet. The network 1601 can include a LAN, a Wide Area Network (WAN), the Internet, wireless transmission mediums, wired transmission mediums, other networks, and combinations thereof. The computing system 1600 may connect to the network 1601 through a network interface unit 1604 connected to the system bus 1622. It should be appreciated that the network interface unit 1604 may also be utilized to connect to other types of networks and remote computing systems. The computing system 1600 also includes an input/output controller 1606 for receiving and processing input from a number of other devices, including a touch user interface display screen, or another type of input device. Similarly, the input/output controller 1606 may provide output to a touch user interface display screen or other type of output device.

As mentioned briefly above, the mass storage device 1614 and the RAM 1610 of the computing system 1600 can store software instructions and data. The software instructions include an operating system 1618 suitable for controlling the operation of the computing system 1600. The mass storage device 1614 and/or the RAM 1610 also store software instructions, that when executed by the one or more processors 1602, cause one or more of the systems, devices, or components described herein to provide functionality described herein. For example, the mass storage device 1614 and/or the RAM 1610 can store software instructions that, when executed by the one or more processors 1602, cause the computing system 1600 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. An audience management platform comprising a computing system including one or more computing devices each having a processor and a memory, the audience management platform comprising:
an interface to a plurality of enterprise data repositories including a user identity database, an affinity propensity database, and a user activity database associated with an enterprise;
a user portal accessible to one or more enterprise user computing devices and configured to generate a user interface that includes:
an audience selection screen useable to select from among a plurality of predefined audiences;
an audience details screen useable to display criteria useable to form a selected audience from among the plurality of predefined audiences and including information regarding a number of members of the selected audience; and
an audience definition screen including a plurality of fields useable to define criteria for forming an audience definition;
wherein the platform is configured to, in response to receipt of the audience definition, generating an audience including a plurality of user identifiers, the plurality of user identifiers corresponding to users meeting the defined criteria, wherein generating the audience includes:
retrieving one or more audience segments, each audience segment including a plurality of user identifiers and being based on a criterium included in the audience definition;
storing the one or more audience segments in an intermediate storage;
formulating the audience based on the audience definition, including combining the one or more audience segments into an aggregated collection of user identifiers obtained from the one or more audience segments.

2. The audience definition platform of claim 1, wherein the user activity database comprises one or more of a sales database, a browse activity database, an engagement database, or a loyalty database.

3. The audience definition platform of claim 1, wherein the defined criteria include predefined enterprise segments, the predefined enterprise segments being used to retrieve collections of user identifiers corresponding to the defined criteria.

4. The audience definition platform of claim 1, wherein the user identifiers include at least one of user cluster identifiers, user profile identifiers, and user email identifiers.

5. The audience definition platform of claim 1, wherein the user identifiers include user cluster identifiers, each user cluster identifier corresponding to one or more user profiles linked together as a common user cluster defining a unique user, the one or more user profiles including an email profile or a payment card profile.

6. The audience management platform of claim 1, wherein the audience segments are dynamically updated based on changes in data in the user identity database, the affinity propensity database, or the user activity database according to a defined update frequency.

7. The audience management platform of claim 1, wherein the behavioral models used to define criteria for audience segments are selected from models predicting user purchasing behavior, user engagement behavior, or user churn behavior.

8. The audience management platform of claim 1, wherein the audience definition screen allows for the combination of multiple criteria using logical operators including AND, OR, and NOT.

9. The audience management platform of claim 1, further comprising an orchestrator configured to perform, in periodic execution cycles:
querying one or more worker services to determine current processing capacity;
retrieving audience definitions and execution plans from an audience database;
updating task completion status based on worker service responses;
submitting new tasks to worker services based on available capacity; and
storing updated execution plan status in the database;
wherein the orchestrator service maintains no state between periodic execution cycles.

10. A method comprising:
receiving an audience definition including a plurality of criteria required of each member of an audience;
generating a technical specification corresponding to the audience definition, the technical specification including a request for an audience including a plurality of user identifiers, the request including at least one of (1) an identification of a previously-identified audience or (2) a specification of an audience to be provided, the specification including a plurality of criteria required of each member of the audience;
generating a technical specification corresponding to the request, the technical specification defining data requests from a plurality of data sources including at least a user identity database, an affinity propensity database, and a user activity database associated with an enterprise;
creating and storing in intermediate storage a plurality of audience segments by identifying user identifiers of potential audience members associated with each criterium of the plurality of criteria based on data obtained from the plurality of data sources in accordance with the technical specification; and
formulating the audience based on the audience definition, including combining the one or more audience segments into an aggregated collection of user identifiers obtained from the plurality of audience segments.

11. The method of claim 10, wherein receiving the audience definition includes at a user interface of an audience management platform includes receiving, at an audience selection screen, a selection of an audience from among a plurality of predefined audiences.

12. The method of claim 10, wherein receiving the audience definition includes receiving a definition of criteria used to form a selected audience from among the plurality of predefined audiences.

13. The method of claim 12, further comprising presenting an audience details screen including information regarding a number of members of the selected audience.

14. The method of claim 10, further comprising receiving a definition of criteria for forming an audience definition.

15. The method of claim 10, wherein the plurality of criteria include behavioral criteria determined by one or more predictive behavioral models and deterministic criteria based on explicit user attributes.

16. The method of claim 10, further comprising dynamically updating the audience segments in intermediate storage based on periodic updates from the plurality of data sources.

17. The method of claim 10, wherein the technical specification includes a frequency of updates for the audience segments.

18. The method of claim 10, wherein combining the one or more audience segments into an aggregated collection of user identifiers obtained from the plurality of audience segments. includes:
loading user identifiers from a first audience segment into a memory buffer while maintaining original ordering of the user identifiers;
sorting the loaded identifiers to create an indexed lookup structure;
streaming user identifiers of a second audience segment sequentially while performing binary search lookups against the sorted first segment in the memory while preserving the original ordering of matched results from the first audience segment.

19. The method of claim 18, wherein combining the one or more audience segments includes:
determining whether user identifiers from the first audience segment and the second audience segment are of a same type;
in response to determining that user identifiers from the first audience segment are of a different type to the user identifiers from the second audience segment, performing a conversion of cluster identifiers in one of the first audience segment or second audience segment by incorporating all profile identifiers associated with each of the cluster identifiers prior to conducting a join operation between the first audience segment and the second audience segment.

20. An audience management system comprising:
a plurality of data sources including a user identity database, an affinity propensity database, and a user activity database associated with an enterprise;
a computing system including one or more processors and a memory;
a user interface accessible via a user portal, the user interface including:
an audience selection screen configured to display a plurality of predefined audiences;
an audience details screen configured to display criteria and a number of members for a selected audience;
an audience definition screen configured to allow definition of criteria for forming an audience;
wherein the computing system is configured to:
generate an audience definition based on received criteria;
create a plurality of audience segments by identifying user identifiers of potential audience members associated with each criterium of the plurality of criteria based on data obtained from the plurality of data sources;
store the audience segments in intermediate storage;
formulate the audience based on the audience definition by combining the audience segments into an aggregated collection of user identifiers; and
dynamically update the audience according to a defined update frequency.

21. The audience management system of claim 20, wherein the audience management system is configured to dynamically update the audience independently of updates to the plurality of audience segments.

22. The audience management system of claim 20, wherein the audience management system is communicatively connected to a communication management system and a user identity platform, the audience management system being separate from the communication management system and the user identity platform.
